(19) United States
(12) Patent Application Publication
(10) Pub. No.: US 2026/0290022 A1
(43) Pub. Date: Sep. 24, 2026

(54) SUSPICIOUS PERSON DETECTION DEVICE, SUSPICIOUS PERSON DETECTION METHOD, AND RECORDING MEDIUM

(71) Applicant: NEC CORPORATION, Tokyo (JP)

(72) Inventors: Ryosuke SHIMIZU, Tokyo (JP); Masaaki KIMURA, Tokyo (JP); Ying XIN, Tokyo (JP); HIDEKI KOYANAGAWA, Tokyo (JP)

(73) Assignee: NEC CORPORATION, Tokyo (JP)

(21) Appl. No.: 19/476,299

(22) PCT Filed: May 18, 2023
(86) PCT No.: PCT/JP2023/018583

§ 371 Date: Oct. 17, 2025

(51) Int. Cl. G06V 20/52; G06Q 50/26; G06V 20/40; G06V 40/10

(52) U.S. Cl. CPC G06V 20/52; G06Q 50/265; G06V 20/40; G06V 40/15

(57) ABSTRACT

This suspicious person detection device includes: one or more memories storing instructions; and one or more processors configured to execute the instructions to: acquire position information indicating the position of a cart used by a person in a store; determine that the movement of the cart is suspicious on the basis of the time-series data of the position information; acquire vital data of a person using the cart when it is determined that the movement of the cart is suspicious; determine whether the person is a suspicious person on the basis of the vital data; and perform notification when it is determined that the person is a suspicious person.

### TECHNICAL FIELD

The present disclosure relates to a suspicious person detection device, a suspicious person detection method, and a recording medium.

### BACKGROUND ART

There is a technique for detecting a suspicious person, using vital data or a video. For example, there is a technique for detecting a person as a suspicious person, based on a mental state analyzed from vibration of the person detected from the video. For example, there is a technique for detecting a person as the suspicious person, in a case where a behavior or a movement of the person detected from the video is suspicious.

PTL 1 describes a suspicious person alarm notification system that alarms in a case where a crime index is high that is calculated based on vital information based on a radar signal, skeleton information of each person imaged in an image, and motion information of the person such as a posture or a direction of an eye line.

### CITATION LIST

### Patent Literature

PTL 1: WO 2022/003447 A1

### SUMMARY OF INVENTION

### Technical Problem

However, if a suspicious person is continuously determined based on vital data of all the persons in a range to be monitored, a processing load may increase.

An example of an object of the present disclosure is to provide a technology for reducing a processing load, in detection of a suspicious person.

### Solution to Problem

A suspicious person detection device according to one aspect of the present disclosure includes position information acquisition means for acquiring position information indicating a position of a cart used by a person in a store, determination means for determining that a movement of the cart is suspicious, based on time-series data of the position information, vital data acquisition means for acquiring vital data of the person who uses the cart, in a case where it is determined that the movement of the cart is suspicious, decision means for determining whether the person is a suspicious person, based on the vital data, and notification means for issuing a notification, in a case where the person is determined as the suspicious person.

A suspicious person detection method according to one aspect of the present disclosure, performed by a computer, includes, acquiring position information indicating a position of a cart used by a person in a store, determining that a movement of the cart is suspicious, based on time-series data of the position information, acquiring vital data of the person who uses the cart, in a case where it is determined that the movement of the cart is suspicious, determining whether the person is a suspicious person, based on the vital data, and issuing a notification, in a case where the person is determined as the suspicious person.

A suspicious person detection program according to one aspect of the present disclosure causes a computer to execute processing including acquiring position information indicating a position of a cart used by a person in a store, determining that a movement of the cart is suspicious, based on time-series data of the position information, acquiring vital data of the person who uses the cart, in a case where it is determined that the movement of the cart is suspicious, determining whether the person is a suspicious person, based on the vital data, and issuing a notification, in a case where the person is determined as the suspicious person.

Each program may be stored in a non-transitory computer-readable recording medium.

### Advantageous Effects of Invention

An example of an effect of the present disclosure is that a processing load can be reduced in detection of a suspicious person.

### BRIEF DESCRIPTION OF DRAWINGS

FIG. 1 is a diagram illustrating an overview of a system including a suspicious person detection device.

FIG. 2 is a block diagram illustrating a functional configuration of the suspicious person detection device.

FIG. 3 is a diagram illustrating an output screen example for a terminal device used by an employee of a store.

FIG. 4 is a diagram illustrating an output screen example for a terminal device used by a person determined to be a suspicious person.

FIG. 5 is a diagram illustrating another example of the output screen example for the terminal device used by the person determined to be the suspicious person.

FIG. 6 is a flowchart illustrating an operation of the suspicious person detection device.

FIG. 7 is a diagram illustrating a hardware configuration for achieving the suspicious person detection device according to the present disclosure by a computer and peripheral devices thereof.

### EXAMPLE EMBODIMENT

Hereinafter, example embodiments of the present disclosure will be described in detail with reference to the drawings.

### First Example Embodiment

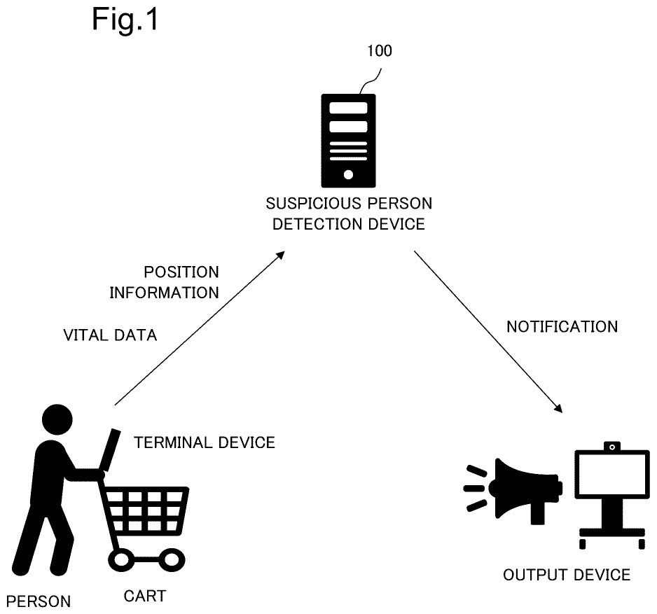

FIG. 1 is a diagram illustrating an overview of a system including a suspicious person detection device 100 according to the present disclosure. The suspicious person detection device 100 detects a suspicious person in a store and issues a notification in order to prevent an illegal act by the suspicious person. In the present disclosure, as a target of the suspicious person detection by the suspicious person detection device 100, a person who has visited the store, that is, a customer of the store is mainly assumed. The suspicious person detection device 100 is communicably connected to a terminal device and an output device.

In FIG. 1, the terminal device is a terminal device provided in a cart used by the person who has visited the store. The terminal device is, for example, a tablet or a smartphone. The terminal device has at least a function for acquiring vital data of a person who uses the cart. The terminal device may be, for example, a terminal device used to scan a product by the person who uses the cart, in self-scan shopping in which the person purchases products while registering the purchased product in the store. The terminal device may be provided in the cart or may be detachably installed in the cart. The cart may be a shopping cart. A basket used for self-scan shopping may be used, instead of the cart.

The output device outputs the notification by the suspicious person detection device 100. The output device may be at least one of a display device or a sound output device. For example, the output device may be at least one of a signage provided in the store, a speaker provided in the store, a terminal device used by a clerk, and a terminal device used by a customer of the store.

Next, a configuration of the suspicious person detection device 100 according to the example embodiment will be described.

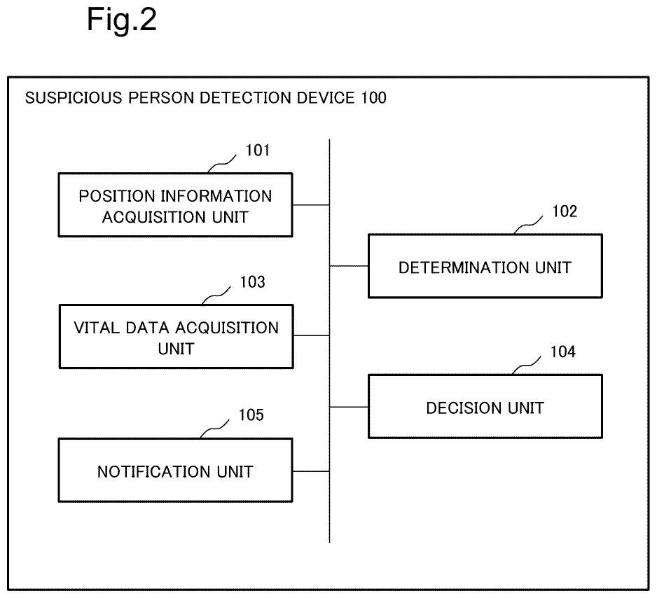

FIG. 2 is a block diagram illustrating the configuration of the suspicious person detection device 100 according to a first example embodiment. Referring to FIG. 2, the suspicious person detection device 100 includes a position information acquisition unit 101, a determination unit 102, a vital data acquisition unit 103, a decision unit 104, and a notification unit 105.

In FIG. 2, the position information acquisition unit 101 is an example of position information acquisition means for acquiring position information indicating a position of the cart used by the person in the store. The position information is information indicating the position of each cart in the store. It is sufficient that the position information acquisition unit 101 acquire position information of at least a cart used by the customer of the store, among the carts existing in the store. The cart used by the customer of the store may be a cart on which self-scan shopping is performed. As the cart used by the customer of the store, a moving cart may be regarded as the cart used by the customer of the store.

For example, the position information acquisition unit 101 acquires position information of a terminal device used for self-scan shopping. At this time, the terminal device is a terminal device provided in the cart or a terminal device detachably installed in the cart. The position information acquisition unit 101 may acquire position information of the terminal device, for example, acquired by a beacon installed in the store performing near field communication with the terminal device.

For example, the position information acquisition unit 101 may acquire the position information, based on a video imaged by a camera such as a monitoring camera in the store. For example, the position information acquisition unit 101 may specify the position of the cart, from a position of a cart detected from the video within an imaging range of the video and a position and a direction of the camera, which has imaged the video, in the store.

The method for acquiring the position information by the position information acquisition unit 101 is not limited to these examples.

The position information acquisition unit 101 may acquire the position information of the cart over time. At this time, the position information acquisition unit 101 may store the acquired position information of the cart, in a storage unit (not illustrated) as time-series data for each cart. The position information acquisition unit 101 may periodically acquire data for a certain period of time or longer in which the position information of the cart and time are associated, as the time-series data.

The determination unit 102 is an example of determination means for determining that a movement of the cart is suspicious, based on the time-series data of the position information of the cart. The determination unit 102 may determine whether the time-series data of the position information of the cart satisfies a condition for determining that the movement of the cart is suspicious. For example, in a case where the movement of the cart deviates from a range of a statistical value of a behavior of the customer in the store, the determination unit 102 may determine that the movement of the cart is suspicious. At this time, the movement of the cart determined to be suspicious is a traffic line of the cart, a feature of the movement of the cart, or the like, specified from the time-series data of the position information of the cart. The traffic line of the cart represents a trajectory, a frequency, and a direction along which a person moves over time. The traffic line of the cart may be any line as long as a period of time when the person has stayed in a set region can be appropriately known, at least. That is, the traffic line of the cart may be the feature of the movement of the cart, a speed of the cart, a feature of the traffic line of the cart, or the like. The determination unit 102 may determine that the movement of the cart is suspicious, using a trained model. The trained model will be described later.

For example, the determination unit 102 determines that the movement of the cart is suspicious, based on the traffic line of the cart specified from the time-series data of the position information of the cart. For example, in a case where the traffic line of the cart includes a specific area, the determination unit 102 may determine that the movement of the cart is suspicious. Here, the specific area is a region in the store where there is a high possibility that an illegal act is performed. The region where there is a high possibility that the illegal act is performed may be a region where the illegal act has been actually performed and a region that satisfies a condition that the illegal act is likely to be performed in general. The region where there is a high possibility that the illegal act is performed may be a region where a product on which the illegal act is likely to be performed is placed. The product on which the illegal act is likely to be performed may be, for example, an expensive product, a popular product that is thinly distributed, or the like. The region that satisfies the condition that the illegal act is likely to be performed in general may be a region to be a blind spot in the store. The region to be the blind spot in the store may be at least one of a region to be a blind spot of the monitoring camera and a region that is likely to be a blind spot from the clerk. The region that satisfies the condition that the illegal act is likely to be performed in general may be a region in the store where the customer does not normally enter. The region in the store where the customer does not normally enter is, for example, a backyard of the store or a region where a cash register clerk works in the store.

For example, in a case where the time-series data of the position information of the cart indicates that the cart has entered the specific area, the determination unit 102 determines that the movement of the cart is suspicious. In a case where the time-series data indicates that the cart has stayed in the specific area for a predetermined period of time or longer, the determination unit 102 may determine that the movement of the cart is suspicious. The fact that the cart has entered the specific area and that the cart has stayed in the specific area for the predetermined period of time or longer may be specified from the traffic line based on the time-series data of the position information of the cart. The predetermined period of time used to determine that the cart has stayed in the specific area may be set to be longer than a staying time, for example, in a case where a person who does not perform an illegal act hesitates to purchase a product in the store. The predetermined period of time used to determine that the cart has stayed in the specific area may be, for example, 3 minutes, 5 minutes, or the like.

For example, in a case where the time-series data of the position information of the cart indicates that the cart has entered and exited from the specific area in the store a predetermined number of times or more, the determination unit 102 may determine that the movement of the cart is suspicious. The fact that the cart has entered and exited from the specific area in the store the predetermined number of times or more may be specified from the traffic line based on the time-series data of the position information of the cart. At this time, it is sufficient that the predetermined number of times be set to be more than the number of times a person who does not perform an illegal act makes a round-trip to another point in a case where the person hesitates to purchase a product in the store, such as 3 times or 5 times.

In a case where the time-series data of the position information of the cart indicates that the cart has gone straight from vicinity of an entrance of the store to the specific area in the store, the determination unit 102 may determine that the movement of the cart is suspicious. The fact that the cart has gone straight from the vicinity of the entrance of the store to the specific area in the store may be specified from the traffic line based on the time-series data of the position information of the cart. For example, it is assumed that a person walk around the store, in the store such as a supermarket. On the other hand, it is assumed that a person who uses the store to perform an illegal act on a product in the specific area may go straight to the specific area without walking around the store. Therefore, in a case where the time-series data indicates that the cart has gone straight from the vicinity of the entrance of the store to the specific area in the store, the determination unit 102 may determine that the movement of the cart is suspicious.

A predetermined movement of the cart related to the specific area, used to determine that the movement of the cart is suspicious, may be set for each specific area.

The determination unit 102 may determine whether a feature of a movement of the person who uses the cart is suspicious, based on the time-series data of the position information of the cart. For example, in a case where the time-series data of the position information of the cart indicates that a moving speed of the cart is outside a predetermined range, the determination unit 102 may determine that the movement of the cart is suspicious. For example, in a case where the time-series data of the position information of the cart indicates that the cart is meandering, the determination unit 102 may determine that the movement of the cart is suspicious.

As described above, the determination unit 102 may determine that the movement of the cart is suspicious, using the trained model. The trained model is a trained model that has learned a relationship between the time-series data of the position information of the cart used by the person and information indicating whether the person has performed the illegal act. The determination unit 102 determines whether the movement of the cart is suspicious, by inputting the time-series data of the position information of the cart into the trained model.

The vital data acquisition unit 103 is an example of vital data acquisition means for acquiring the vital data of the person who uses the cart, in a case where the determination unit 102 has determined that the movement of the cart is suspicious. The vital data of the person may be at least one of physiological information of the person, information indicating an inner state of the person, and information indicating a mental state of the person. The vital data may be, for example, a heart rate, a respiratory rate, a body temperature, an opening degree of a pupil, or the like, which are the physiological information. For example, the vital data may be a numerical value of a stress value estimated by using various types of physiological information or an inner state or a mental state of the person such as a tension level or an aggressiveness.

The vital data acquisition unit 103 may acquire vital data measured by a sensor. The sensor is, for example, a sensor provided in the terminal device or a sensor communicably connected to the terminal device. For example, the vital data acquisition unit 103 may acquire vital data measured by a sensor provided in a wearable terminal connected to the terminal device. The vital data acquisition unit 103 may acquire vital data detected by a sensor that is communicably connected to the terminal device and is provided in a handle portion of the cart used to carry products in the store.

The vital data acquisition unit 103 may acquire vital data estimated based on a video. At this time, the video may be a video of the person imaged by a camera of the terminal device provided in the cart. The vital data acquisition unit 103 may acquire the video from the camera provided in the terminal device which is a tablet or a smartphone and extract the vital data from the video. For example, the vital data acquisition unit 103 may acquire the vital data extracted from the video by the terminal device. The vital data based on the video is extracted, by analyzing a change in a facial color, a movement of a face, a line-of-sight, blinks, a pupil diameter, a movement of an iris, an expression, or the like, included in a face video of the person imaged by the camera.

As described above, in a case where the position information acquisition unit 101 acquires the position information of the cart based on the video, the vital data acquisition unit 103 specifies a terminal device related to the position information of the cart. For example, the vital data acquisition unit 103 may specify the terminal device from the position information of the cart, by collating a face image of a person who uses the terminal device, imaged by the terminal device and a face image of a person included in an image imaged by the camera for specifying the position information, such as a monitoring camera.

The vital data acquisition unit 103 may acquire the vital data of the person from the terminal device, in a case where the determination unit 102 determines that the movement of the cart is suspicious. The vital data acquisition unit 103 may cause the terminal device to execute a movement to detect the vital data of the person, in a case where the determination unit 102 determines that the movement of the cart is suspicious. For example, the vital data acquisition unit 103 may cause the terminal device to start to image a video of a face of the person used to detect the vital data, in a case where the determination unit 102 determines that the movement of the cart is suspicious.

The vital data acquisition unit 103 may acquire the vital data at a time point when the determination unit 102 determines that the movement of the cart is suspicious. Alternatively, the vital data acquisition unit 103 may acquire time-series data of the vital data. For example, the vital data acquisition unit 103 may acquire the vital data in a predetermined period up to the time point when the determination unit 102 determines that the movement of the cart is suspicious. For example, the vital data acquisition unit 103 may acquire, over time, the vital data at and after the time point when the determination unit 102 determines that the movement of the cart is suspicious.

The decision unit 104 is an example of decision means for determining whether the person is a suspicious person, based on the vital data of the person acquired by the vital data acquisition unit 103. In a case where the vital data of the person indicates that the person is in a mental state where the person intends to perform an illegal act, the decision unit 104 determines that the person is the suspicious person.

Here, the illegal act is a criminal act, a violent act, intimidation, or the like. For example, the illegal act in the store is a criminal act such as shoplifting, burglary, or a damage of a product. Generally, in a case where an illegal act is performed and in a case where an illegal act is to be performed, the person has a change in emotion such as being excited, an increase in the aggressiveness, an increase in the tension level, or an increase in the stress. Such a change in emotion may appear in the vital data. For example, the change in the vital data in a case where the illegal act is performed or the illegal act is to be performed is a change such as an increase in the heart rate, an increase in a skin temperature, an increase in the respiratory rate, or opening of the pupil.

Therefore, in a case where a numerical value indicated by the vital data exceeds a predetermined threshold or in a case where a change amount of the numerical value indicated by the vital data exceeds the predetermined threshold, the decision unit 104 may determine that the person is the suspicious person. For example, in a case where the change in the vital data is similar to the change in the vital data in a case where the illegal act is performed, the decision unit 104 may determine that the person is the suspicious person. Here, the similarity may be that a difference is equal to or less than a certain value or a similarity is larger than a threshold. It is sufficient that the decision unit 104 determine that the person is the suspicious person, under a condition appropriately determined according to the vital data to be used, without being limited to these examples.

The notification unit 105 is an example of notification means for issuing a notification, in a case where it is determined that the person is the suspicious person. Specifically, the notification unit 105 causes the output device to issue a notification. As described above, the notification unit 105 issues the notification for preventing the illegal act by the suspicious person. The notification for preventing the illegal act by the suspicious person may be, for example, a notification for preventing an illegal act by attracting attention of a person determined to be a suspicious person. The notification for preventing the illegal act by the suspicious person may be a notification for causing an employee of the store to take measures to prevent the illegal act, by notifying the employee of the store of information regarding the person determined to be the suspicious person. It is sufficient for the notification unit 105 to issue at least one or more notifications described above.

Content of the notification for preventing the illegal act by attracting attention of the person determined to be the suspicious person is not particularly limited. For example, the notification for preventing the illegal act by attracting attention of the person determined to be the suspicious person may have content for regulating the illegal act such as “shoplifting is a crime”, “a security guard goes on patrol”, or “beware of a suspicious person”. The notification for preventing the illegal act by attracting attention of the person determined to be the suspicious person may have content that is not related to the illegal act, such as an advertisement of a store or a notification for starting an inquiry to a clerk such as “May I help you?”. By issuing the notification having the content that is not related to the illegal act by the notification unit 105, in a case where the person determined as the suspicious person does not intend to perform the illegal act, it is possible to prevent the person from feeling that the person is suspected and to prevent a satisfaction of a customer in the store from being lowered or stimulating a person with increased aggressiveness.

The notification of the information regarding the person determined to be the suspicious person used to cause the employee of the store to take measures to prevent the illegal act is only required to include content from which the employee of the store can recognize the suspicious person or a place of the suspicious person. For example, the notification in this case is only required to include information indicating at least one of a feature of an appearance of the suspicious person and a position of the suspicious person in the store. At this time, the notification may include information indicating at least one of the vital data of the person and the movement of the cart used by the person, that is a reason why it is determined that the person is the suspicious person.

The device that outputs the notification by the notification unit 105 may be at least one of the terminal device used by the person, the output device installed in the store, and the terminal device used by the employee of the store.

For example, in a case where it is determined that the person is the suspicious person, the notification unit 105 causes the output device to issue a sound notification. At this time, the sound is sound that attracts attention of the person determined as the suspicious person. By outputting the sound that attracts attention of the person by the output device, in a case where the person intends to perform the illegal act, it is possible to distract the person and prevent the illegal act. In this case, the notification unit 105 causes a speaker used for broadcasting in the store or a speaker of the terminal device used by the person, to issue a notification for outputting the sound. For example, the sound of the notification in a case where the person is determined as the suspicious person may be a sound notification that notifies the employee of the store that the suspicious person is in the store. In this case, the notification unit 105 issues a notification for causing the speaker used for broadcasting in the store or a sound output device of the terminal device used by the employee, to output the sound.

For example, in a case where the person is determined as the suspicious person, the notification unit 105 issues a display notification. At this time, the display is display that attracts attention of the person determined as the suspicious person. By making the display that attracts attention of the person by the output device, in a case where the person intends to perform the illegal act, it is possible to distract the person and prevent the illegal act. In this case, the notification unit 105 issues a notification for displaying the notification on a display unit of the terminal device used by the person or a display device such as a signage installed in the store. For example, the notification in a case where the person is determined as the suspicious person may be display that notifies the employee of the store that the suspicious person is in the store. In this case, the notification unit 105 issues a notification for displaying the notification on a display device such as a tablet terminal, a smartphone, or a Point Of Sales (POS) terminal used by the employee.

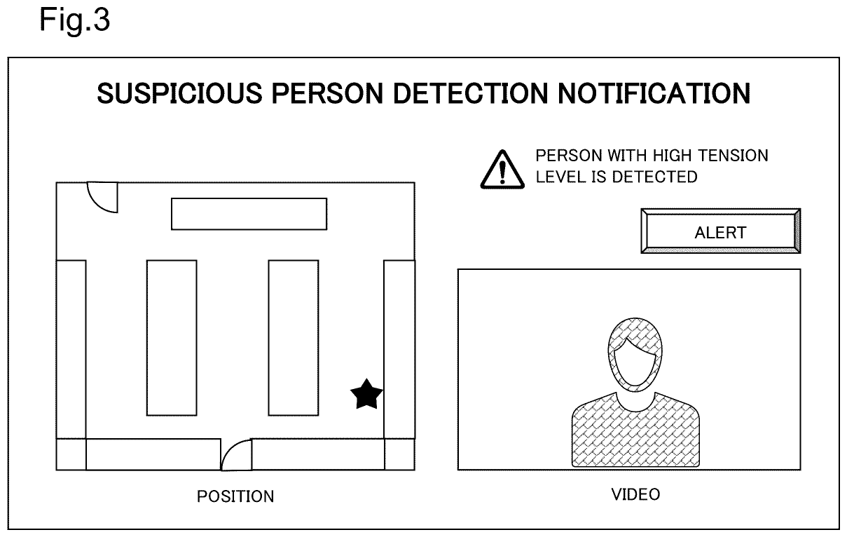

FIG. 3 is an output screen example of the notification for the terminal device used by the employee of the store. In FIG. 3, the output screen includes information indicating that a suspicious person has been detected, a position of the suspicious person in the store, and an image of a face of the suspicious person. In addition, in FIG. 3, an output screen of an alert includes an “alert” button. For example, in a case where the “alert” button is selected on the output screen of the alert to the employee, the notification unit 105 may output an alert for notifying another employee or a security guard that the suspicious person is detected. For example, in a case where the button described above is selected, the notification unit 105 may output an alert to the person detected as the suspicious person. In this way, because the employee can determine whether to issue the alert, it is considered that there is a case where it is possible to prevent erroneous issuance of an alert to a person who is unlikely to perform an illegal act or stimulation of a person with increasing aggressiveness.

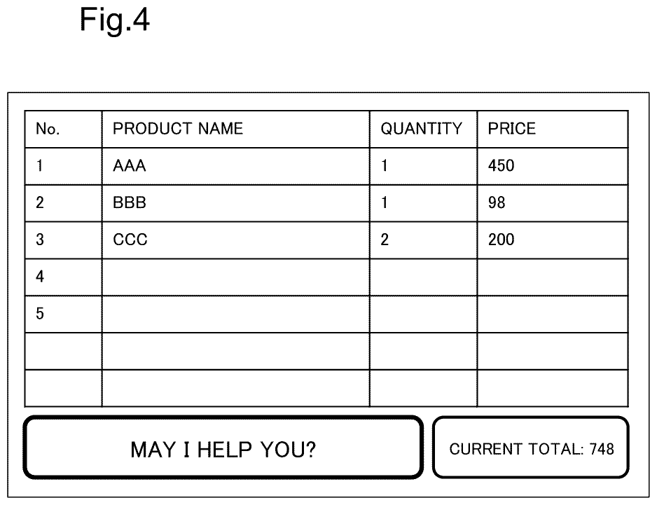

FIG. 4 is an output screen example of a notification to a terminal device used by the person determined as the suspicious person. In FIG. 4, in the output screen, a self-scan shopping screen includes display of “May I help you?”. If this display is displayed together with notification sound, there is a case where an effect of preventing the illegal act is increased because the display attracts attention of the person. As described above, the output screen may include display having content that restricts illegal acts such as “no shoplifting”, in addition to the notification having the content that does not indicate the illegal act such as “May I help you?”. Although the self-scan shopping screen includes a list of products registered as purchased products and a current total amount of the purchased products, the self-scan shopping screen is not limited to this example. Although the notification is displayed on a partial range of the screen of the terminal device of the person in the example in FIG. 4, the notification may be displayed on an entire screen of the terminal device of the person.

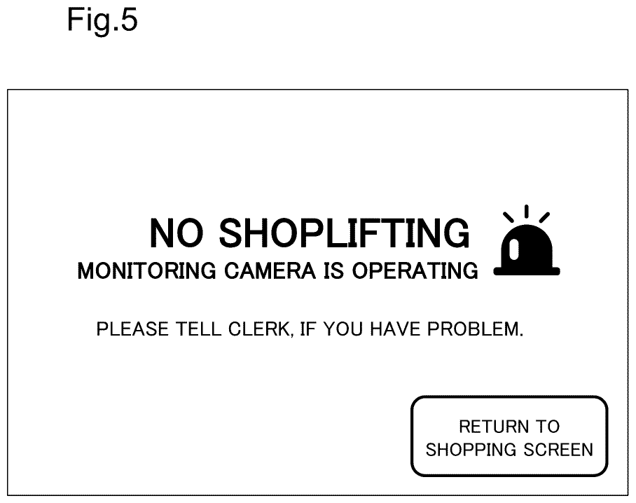

FIG. 5 is another output screen example of the notification to the terminal device used by the person determined as the suspicious person. In FIG. 5, the output screen includes words such as “no shoplifting”, “the monitoring camera is operating”, or “please tell the clerk if you have a problem”, as the notification for preventing the illegal act by attracting attention of the person. In FIG. 5, the output screen includes a button used to return to the self-scan shopping screen. For example, in a case where the button used to return to the self-scan shopping screen is pressed or in a case where a new product is registered, the terminal device may return the display from the output screen in FIG. 5 to the self-scan shopping screen.

Although examples of the notification in a case where the person is determined as the suspicious person have been described above, these notifications may be appropriately combined and executed. The notification method may be appropriately changed, according to the movement of the cart of the person and the vital data of the person. For example, in a case where the vital data indicates that the aggressiveness of the person is increased, it is possible not to directly stimulate the person, by issuing the notification to the clerk.

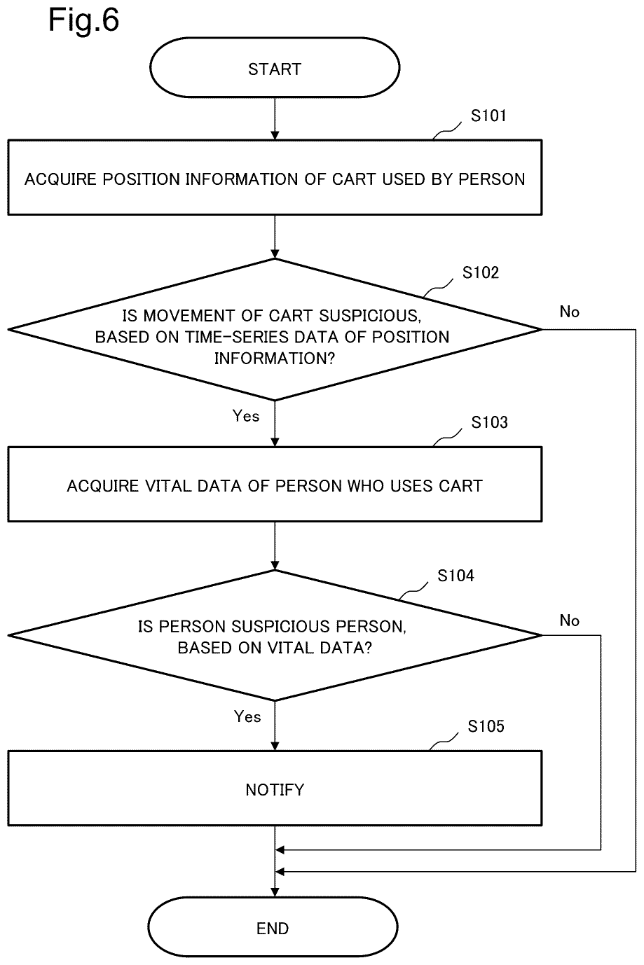

An operation of the suspicious person detection device 100 configured in this way will be described with reference to the flowchart in FIG. 6.

As illustrated in FIG. 6, first, the position information acquisition unit 101 acquires the position information of the cart used by the person (step S101).

Next, the determination unit 102 determines whether the movement of the cart based on the time-series data of the position information of the cart is suspicious (step S102). In a case where it is determined in step S102 that the movement of the cart based on the time-series data of the position information of the cart is not suspicious (step S102: No), the suspicious person detection device 100 ends the series of operations. Even in a case where it is determined in step S102 that the movement of the cart based on the time-series data of the position information of the cart is not suspicious, if the person uses the cart, the suspicious person detection device 100 may return to the operation in step S101 again.

In a case where it is determined in step S102 that the movement of the cart based on the time-series data of the position information of the cart is suspicious (step S102: Yes), the vital data acquisition unit 103 acquires the vital data of the person who uses the cart (step S103).

Next, the decision unit 104 determines whether the person is a suspicious person, based on the vital data acquired in step S103 (step S104). In a case where it is determined in step S104 that the person is not the suspicious person (step S104: No), the suspicious person detection device 100 ends the series of operations. As in a case of step S102, even in a case where it is determined in step S104 that the person is not the suspicious person, if the person uses the cart, the suspicious person detection device 100 may return to the operation in step S101 again.

In a case where it is determined in step S104 that the person is the suspicious person (step S104: Yes), the notification unit 105 issues the notification for preventing the illegal act by the suspicious person.

As described above, the suspicious person detection device 100 ends the series of operations.

In the suspicious person detection device 100 according to the present example embodiment described above, the determination unit 102 determines whether the movement of the cart based on the time-series data of the position information of the cart is suspicious. Then, in a case where the determination unit 102 determines that the movement of the cart is suspicious, the vital data acquisition unit 103 acquires the vital data of the person who uses the cart. Then, the decision unit 104 determines whether the person is the suspicious person based on the vital data of the person, and the notification unit 105 issues the notification in a case where the person is determined as the suspicious person.

As a result, the suspicious person detection device 100 according to the present example embodiment can reduce a processing load in the detection of the suspicious person. For example, the suspicious person detection device 100 according to the present example embodiment narrows the vital data monitoring target used to detect the suspicious person, by using the position information of the cart used by the person and the movement of the cart specified from the position information, in the detection of the suspicious person based on the vital data. As a result, the suspicious person detection device 100 according to the present example embodiment does not need to monitor the vital data of all the persons who are targets of the detection of the suspicious person.

Therefore, the suspicious person detection device 100 according to the present example embodiment can reduce the processing load in the detection of the suspicious person based on the vital data.

### Hardware Configuration

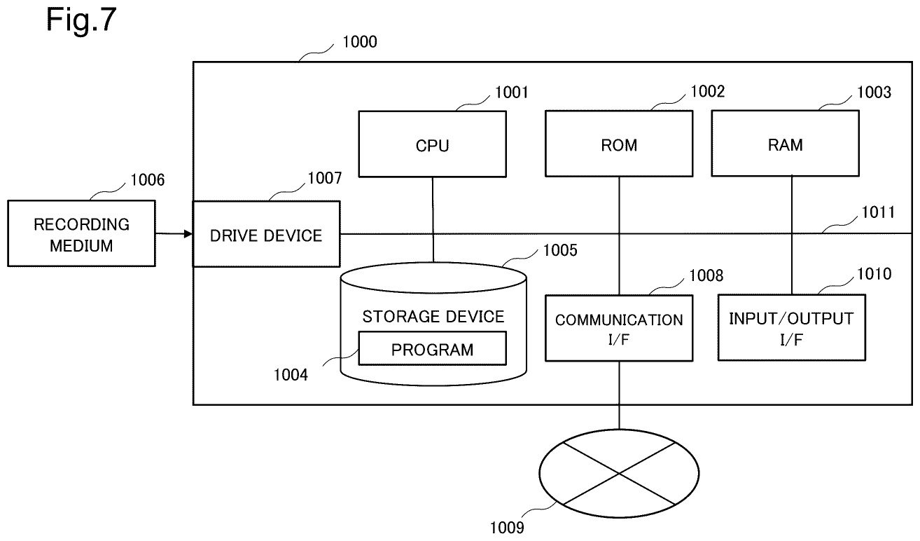

Some or all of the components of each device or system in each example embodiment of the present disclosure described above are achieved by, for example, any combination of an information processing apparatus 1000 and a program as illustrated in FIG. 7. As an example, the information processing apparatus 1000 includes the following components.
A Central Processing Unit (CPU) 1001
Read Only Memory (ROM) 1002
Random Access Memory (RAM) 1003
A program 1004 loaded into the RAM 1003
A storage device 1005 storing the program 1004
A drive device 1007 for reading/writing a recording medium 1006
A communication I/F 1008 connected to a communication network 1009
An input/output I/F 1010 for inputting/outputting data
A bus 1011 connecting each component
I/F is an abbreviation of Interface.

Each component of each apparatus or system in each example embodiment is achieved by the CPU 1001 acquiring and executing a program for achieving these functions. The program for achieving the function of each component of each apparatus is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method for achieving each apparatus. For example, each apparatus or system may be achieved by any combination of the information processing apparatus 1000 and the program separate for each component. A plurality of components included in each apparatus may be achieved by any combination of one information processing apparatus 1000 and the program.

Some or all of the components of each apparatus or system are achieved by a general-purpose or dedicated circuitry including a processor or the like, or a combination thereof. The circuitry is, for example, a CPU, a Graphics Processing Unit (GPU), a Field Programmable Gate Array (FPGA), or a Large Scale Integration (LSI) for Artificial Intelligence (AI) processing. These may be configured by a single chip or may be configured by a plurality of chips connected via a bus. Some or all of the components of each apparatus may be achieved by a combination of the above-described circuitry and the like and the program.

In a case where some or all of the components of each apparatus or system are achieved by a plurality of the information processing apparatuses, circuitries, and the like, the plurality of information processing apparatuses, circuitries, and the like may be arranged in a centralized manner or in a distributed manner. For example, each of the information processing apparatuses, circuitry, and the like may be achieved in the form of a client server system, a cloud computing system, and the like in which they are connected to each other through the communication network.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

Although a plurality of operations is described in order in the form of the flowchart, the order of description does not limit the order of executing the plurality of operations. Therefore, when each example embodiment is implemented, the order of the plurality of operations may be changed within a range that does not interfere with the content.

Some or all of the above-described example embodiments may be described as the following supplementary notes, but are not limited to the following.

### Supplementary Note 1

A suspicious person detection device including:
position information acquisition means for acquiring position information indicating a position of a cart used by a person in a store;
determination means for determining that a movement of the cart is suspicious, based on time-series data of the position information; vital data acquisition means for acquiring vital data of the person who uses the cart, in a case where it is determined that the movement of the cart is suspicious;
decision means for determining whether the person is a suspicious person, based on the vital data; and
notification means for issuing a notification, in a case where the person is determined as the suspicious person.

### Supplementary Note 2

The suspicious person detection device according to supplementary note 1, in which
the determination means determines that the movement of the cart is suspicious, based on a traffic line of the cart specified based on the time-series data of the position information.

### Supplementary Note 3

The suspicious person detection device according to supplementary note 2, in which
in a case where the time-series data of the position information indicates that the cart has entered a specific area in the store, the determination means determines that the movement of the cart is suspicious.

### Supplementary Note 4

The suspicious person detection device according to supplementary note 2 or 3, in which
in a case where the time-series data of the position information indicates that the cart has stayed in the specific area in the store for a predetermined period of time or longer, the determination means determines that the movement of the cart is suspicious.

### Supplementary Note 5

The suspicious person detection device according to any one of supplementary notes 2 to 4, in which
in a case where the time-series data of the position information indicates that the cart has entered and exited from the specific area in the store a predetermined number of times or more, the determination means determines that the movement of the cart is suspicious.

### Supplementary Note 6

The suspicious person detection device according to any one of supplementary notes 2 to 5, in which
in a case where the time-series data of the position information indicates that the cart has gone straight from vicinity of an entrance of the store to the specific area in the store, the determination means determines that the movement of the cart is suspicious.

### Supplementary Note 7

The suspicious person detection device according to any one of supplementary notes 3 to 6, in which
the specific area is an area where an illegal act is often performed.

### Supplementary Note 8

The suspicious person detection device according to any one of supplementary notes 3 to 7, in which
the specific area is an area to be a blind spot in the store.

### Supplementary Note 9

The suspicious person detection device according to any one of supplementary notes 1 to 8, in which
the determination means determines that the movement of the cart is suspicious, based on a feature of the movement of the cart specified based on the time-series data of the position information.

### Supplementary Note 10

The suspicious person detection device according to supplementary note 9, in which
in a case where the time-series data of the position information indicates that a moving speed of the cart is outside a predetermined range, the determination means determines that the movement of the cart is suspicious.

### Supplementary Note 11

The suspicious person detection device according to supplementary note 9 or 10, in which
in a case where the time-series data of the position information indicates that the cart is meandering, the determination means determines that the movement of the cart is suspicious.

### Supplementary Note 12

The suspicious person detection device according to any one of supplementary notes 1 to 11, in which
the determination means determines that the movement of the cart is suspicious, by inputting the time-series data of the position information, into a trained model that has learned a relationship between the time-series data of the position information of the cart used by the person and information indicating whether the person has performed an illegal act.

### Supplementary Note 13

The suspicious person detection device according to any one of supplementary notes 1 to 12, in which
the vital data acquisition means acquires the vital data of the person, from a video of the person imaged by a camera of a terminal device installed in the cart.

### Supplementary Note 14

The suspicious person detection device according to any one of supplementary notes 1 to 13, in which
in a case where the person is determined as the suspicious person, the notification means issues a notification to a terminal device used by the person.

### Supplementary Note 15

The suspicious person detection device according to any one of supplementary notes 1 to 14, in which in a case where the person is determined as the suspicious person, the notification means issues a sound notification.

### Supplementary Note 16

The suspicious person detection device according to any one of supplementary notes 1 to 15, in which
in a case where the person is determined as the suspicious person, the notification means notifies a terminal device used by an employee of the store of the position information and the vital data.

### Supplementary Note 17

The suspicious person detection device according to any one of supplementary notes 1 to 16, in which
in a case where the vital data indicates that the person is excited, the decision means determines that the person is the suspicious person.

### Supplementary Note 18

The suspicious person detection device according to any one of supplementary notes 1 to 17, in which
in a case where the vital data indicates that aggressiveness of the person is increased, the decision means determines that the person is the suspicious person.

### Supplementary Note 19

A suspicious person detection method performed by a computer, including:
acquiring position information indicating a position of a cart used by a person in a store;
determining that a movement of the cart is suspicious, based on time-series data of the position information;
acquiring vital data of the person who uses the cart, in a case where it is determined that the movement of the cart is suspicious;
determining whether the person is a suspicious person, based on the vital data; and
issuing a notification, in a case where the person is determined as the suspicious person.

### Supplementary Note 20

A recording medium recording a program for causing a computer to execute processing including:
acquiring position information indicating a position of a cart used by a person in a store;
determining that a movement of the cart is suspicious, based on time-series data of the position information;
acquiring vital data of the person who uses the cart, in a case where it is determined that the movement of the cart is suspicious;
determining whether the person is a suspicious person, based on the vital data; and
issuing a notification, in a case where the person is determined as the suspicious person.

### REFERENCE SIGNS LIST

100 suspicious person detection device
101 position information acquisition unit
102 determination unit
103 vital data acquisition unit
104 decision unit
105 notification unit
1000 information processing apparatus
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. A suspicious person detection device comprising:
one or more memories storing instructions; and
one or more processors configured to execute the instructions to:
acquire position information indicating a position of a cart used by a person in a store;
determination determine that a movement of the cart is suspicious, based on time-series data of the position information;
vital acquire vital data of the person who uses the cart, in a case where it is determined that the movement of the cart is suspicious;
determine whether the person is a suspicious person, based on the vital data; and
issue a notification, in a case where the person is determined as the suspicious person.

2. The suspicious person detection device according to claim 1, wherein the one or more processors are configured to execute the instructions to:
determine that the movement of the cart is suspicious, based on a traffic line of the cart specified based on the time-series data of the position information.

3. The suspicious person detection device according to claim 2, wherein the one or more processors are configured to execute the instructions to:
in a case where the traffic line of the cart specified based on the time-series data of the position information indicates that the cart has entered a specific area in the store, determine that the movement of the cart is suspicious.

4. The suspicious person detection device according to claim 2, wherein the one or more processors are configured to execute the instructions to:
in a case where the traffic line of the cart specified based on the time-series data of the position information indicates that the cart has stayed in the specific area in the store for a predetermined period of time or longer, determine that the movement of the cart is suspicious.

5. The suspicious person detection device according to claim 2, wherein the one or more processors are configured to execute the instructions to:
in a case where the traffic line of the cart specified based on the time-series data of the position information indicates that the cart has entered and exited from the specific area in the store a predetermined number of times or more, determine that the movement of the cart is suspicious.

6. The suspicious person detection device according to claim 1, wherein the one or more processors are configured to execute the instructions to:
in a case where the traffic line of the cart specified based on the time-series data of the position information indicates that the cart has gone straight from vicinity of an entrance of the store to the specific area in the store, determine that the movement of the cart is suspicious.

7. The suspicious person detection device according to claim 3, wherein
the specific area is an area where an illegal act is often performed.

8. The suspicious person detection device according to claim 3, wherein
the specific area is an area to be a blind spot in the store.

9. The suspicious person detection device according to claim 1, wherein the one or more processors are configured to execute the instructions to:
determine that the movement of the cart is suspicious, based on a feature of the movement of the cart specified based on the time-series data of the position information.

10. The suspicious person detection device according to claim 9, wherein the one or more processors are configured to execute the instructions to:
in a case where the time-series data of the position information indicates that a moving speed of the cart is outside a predetermined range, determine that the movement of the cart is suspicious.

11. The suspicious person detection device according to claim 9, wherein the one or more processors are configured to execute the instructions to:
in a case where the time-series data of the position information indicates that the cart is meandering, determine that the movement of the cart is suspicious.

12. The suspicious person detection device according to claim 1, wherein the one or more processors are configured to execute the instructions to:
determine that the movement of the cart is suspicious, by inputting the time-series data of the position information, into a trained model that has learned a relationship between the time-series data of the position information of the cart used by the person and information indicating whether the person has performed an illegal act.

13. The suspicious person detection device according to claim 1, wherein the one or more processors are configured to execute the instructions to:
acquire the vital data of the person, from a video of the person imaged by a camera of a terminal device installed in the cart.

14. The suspicious person detection device according to claim 1, wherein the one or more processors are configured to execute the instructions to:
in a case where the person is determined as the suspicious person, issue a notification to a terminal device used by the person.

15. The suspicious person detection device according to claim 1, wherein the one or more processors are configured to execute the instructions to:
in a case where the person is determined as the suspicious person, issue a sound notification.

16. The suspicious person detection device according to claim 1, wherein the one or more processors are configured to execute the instructions to:
in a case where the person is determined as the suspicious person, notify a terminal device used by an employee of the store of the position information and the vital data.

17. The suspicious person detection device according to claim 1, wherein the one or more processors are configured to execute the instructions to:
in a case where the vital data indicates that the person is excited, determine that the person is the suspicious person.

18. The suspicious person detection device according to claim 1, wherein the one or more processors are configured to execute the instructions to:
in a case where the vital data indicates that aggressiveness of the person is increased, determine that the person is the suspicious person.

19. A suspicious person detection method performed by a computer, comprising:
acquiring position information indicating a position of a cart used by a person in a store;
determining that a movement of the cart is suspicious, based on time-series data of the position information;
acquiring vital data of the person who uses the cart, in a case where it is determined that the movement of the cart is suspicious;
determining whether the person is a suspicious person, based on the vital data; and
issuing a notification, in a case where the person is determined as the suspicious person.

20. A non-transitory recording medium recording a program for causing a computer to execute processing comprising:
acquiring position information indicating a position of a cart used by a person in a store;
determining that a movement of the cart is suspicious, based on time-series data of the position information;
acquiring vital data of the person who uses the cart, in a case where it is determined that the movement of the cart is suspicious;
determining whether the person is a suspicious person, based on the vital data; and
issuing a notification, in a case where the person is determined as the suspicious person.
